(19) United States
(12) Patent Application Publication
(10) Pub. No.: US 2008/0259639 A1
(43) Pub. Date: Oct. 23, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/835,428

(22) Filed: Aug. 8, 2007

(30) Foreign Application Priority Data
Apr. 18, 2007 (CN) 200710200478.9

(51) Int. Cl. F21V 8/00; F21V 7/00

(52) U.S. Cl. 362/607; 362/606; 362/619

(57) ABSTRACT

An exemplary optical plate includes at least one transparent plate section. The transparent plate section includes a light output surface, a bottom surface, a plurality of depressions and at least one lamp-receiving portion. The light output surface is opposite to the bottom surface. The depressions are formed on the light output surface. The lamp-receiving portion is defined in the bottom surface. A backlight module using the present optical plate is also provided.

### CROSS-REFERENCE TO RELATED APPLICATIONS

This application is related to six copending U.S. patent applications, which are: applications Ser. No. [to be advised], Attorney Docket No. US13925, US13926, US13927, US14376, US14378, and US 14382, and entitled “OPTICAL PLATE AND BACKLIGHT MODULE USING THE SAME”. In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

In a liquid crystal display device, liquid crystal is a substance that does not itself radiate light. Instead, the liquid crystal relies on light received from a light source, to provide displaying of images and data. In the case of a typical liquid crystal display device, a backlight module powered by electricity supplies the needed light.

FIG. 11 represents a typical direct type backlight module 100. The backlight module 100 includes a housing 101, a light reflective plate 102, a light diffusion plate 103, a prism sheet 104, and a plurality of light emitting diodes 105 (hereafter called LED). The housing 101 includes a rectangular base 1011 and four sidewalls 1013 extending around a periphery of the base 1011. The base 1011 and the four sidewalls 1013 cooperatively define a chamber 1017. Each LED 105 includes a base portion 1053 and a light-emitting portion 1051 disposed on the base portion 1053. The LEDs 105 are electrically connected to a printed circuit board 106, and the printed circuit board 106 is fixed to the base 1011 of the housing 101. The light reflective plate 102 is disposed on the LEDs 105 in the chamber 1017. The light reflective plate 102 defines a plurality of through holes (not labeled) exposing the light-emitting portions 1051 of the LED 105 to emit light to enter the light diffusion plate 103. The light diffusion plate 103 and the prism sheet 104 are stacked in that order on the chamber 1017. Light emitted from the LEDs 105 is substantially reflected by the light reflective plate 102 to enter the light diffusion plate, and diffused uniformly in the light diffusion plate 103, and finally surface light is outputted from the prism sheet 104.

Generally, a plurality of potential dark areas may occur because of the reduced intensity of light between adjacent LEDs 105. In the backlight module 100, each LED 105 further includes a reflective sheet 1057 disposed on the top of the light-emitting portion 1051, configured for decreasing the brightness of a portion of the backlight module 100 above the LED 105. However, the brightness of the backlight module 100 is not uniform. One method of enhancing the uniformity of brightness of the backlight module 100 is to increase a space between the light diffusion plate 103 and the LEDs 105. This increasing space tends to eliminate potential dark areas. However, increasing the space between the light diffusion plate 103 and the LEDs 105 will also increase the thickness of the backlight module 100, and the further overall intensity of the output light is reduced.

What is needed, therefore, is a new optical plate and a backlight module using the optical plate that can overcome the above-mentioned shortcomings.

### SUMMARY

An optical plate according to a preferred embodiment includes at least one transparent plate section. The transparent plate section includes a light output surface, a bottom surface, a plurality of depressions and at least one lamp-receiving portion. The light output surface is opposite to the bottom surface. The depressions are formed on the light output surface. The lamp-receiving portion is defined in the bottom surface.

A backlight module according to a preferred embodiment includes a housing, at least one side-lighting type point light source, an optical plate, and a light diffusion plate. The housing includes a base and a plurality of sidewalls extending around a periphery of the base, the base and the sidewalls cooperatively defining an opening. The at least one point light source is disposed on the base and has a light-emitting portion. The same optical plate as described in the previous paragraph is employed in this embodiment. The light-emitting portion of the at least one point light source is inserted in the lamp receiving portion of the optical plate correspondingly. The light diffusion plate is disposed on the housing over the opening.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of the optical plate according to a first preferred embodiment of the present invention.

FIG. 2 is a side cross-sectional view taken along line II-II of FIG. 1.

FIG. 3 is a side cross-sectional view of a backlight module using the optical plate shown in FIG. 1 according to a second preferred embodiment of the present invention.

FIG. 4 is an enlarged view of a circle portion IV of FIG. 3.

FIG. 5 is an isometric view of an optical plate according to a third preferred embodiment of the present invention.

FIG. 6 is a cross-sectional view taken along line VI-VI of FIG. 5.

FIG. 7 is a side cross-sectional view of an optical plate according to a fourth preferred embodiment of the present invention.

FIG. 8 is a side cross-sectional view of an optical plate according to a fifth preferred embodiment of the present invention.

FIG. 9 is a top plane view of an optical plate according to a sixth preferred embodiment of the present invention.

FIG. 10 is a top plane view of an optical plate according to a seventh preferred embodiment of the present invention.

FIG. 11 is a side cross-sectional view of a conventional backlight module.

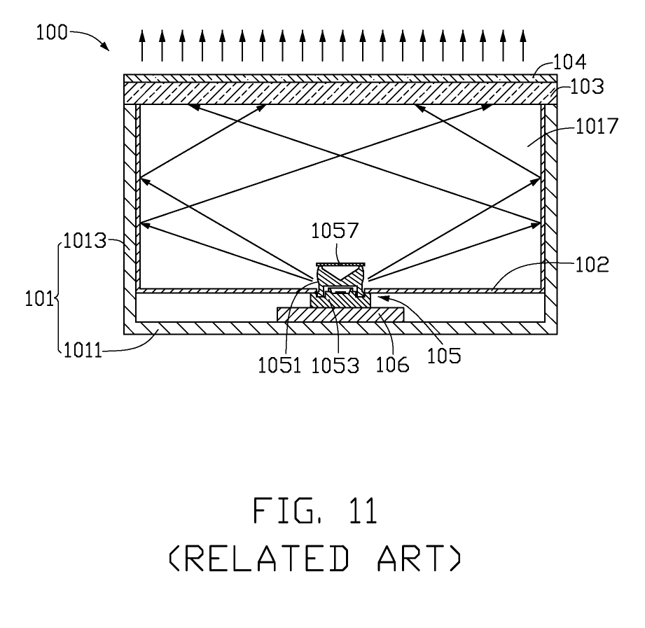

### DETAILED DESCRIPTION OF THE PREFERRED EMBODIMENTS

Reference will now be made to the drawings to describe preferred embodiments of the present optical plate and backlight module, in details.

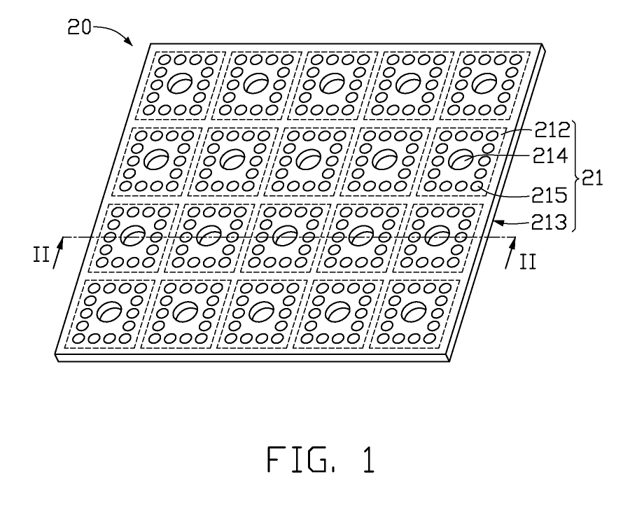

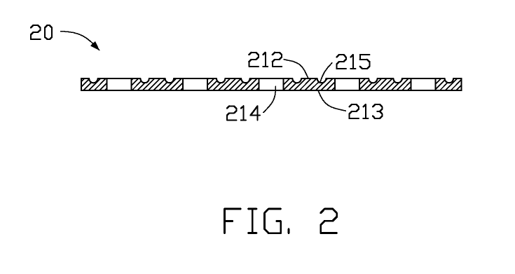

Referring to FIGS. 1 and 2, an optical plate 20 in accordance with a first preferred embodiment of the present invention is shown. The optical plate 20 is a transparent square plate, which includes a light output surface 212, a bottom surface 213, a plurality of lamp-receiving portions 214, and a plurality of depressions 215. The bottom surface 213 and the light output surface 212 are on opposite sides of the optical plate 20. The depressions 215 are formed on the light output surface 212. The lamp-receiving portions 214 are formed on the bottom surface 213. In this embodiment, the optical plate 20 can be divided into twenty smaller square transparent plate sections 21 in a matrix manner. Each transparent plate section 21 defines the lamp-receiving portion 214 in a center, and the depressions 215 are formed surrounding the lamp-receiving portion 214. Each of the lamp-receiving portions 214 is preferably a through hole communicating between the light output surface 212 and the bottom surface 213. In each transparent plate section 21, the depressions 215 are formed on the light output surface 212 in a rectangular manner surrounding the lamp-receiving portion 214. In the preferred embodiment, the depressions 215 are spherical depressions.

The optical plate 20 can be made from material selected from the group consisting of polycarbonate (PC), polymethyl methacrylate (PMMA), polystyrene (PS), copolymer of methylmethacrylate and styrene (MS), and any suitable combination thereof. A thickness of the optical plate 20 is preferably in a range from 0.5 millimeters to about 5 millimeters. A radius defined by the depressions 215 is preferably in a range from about 0.01 millimeters to about 2 millimeters. A maximum depth of each depression 215 is in a range from about 0.01 millimeters to about 2 millimeters.

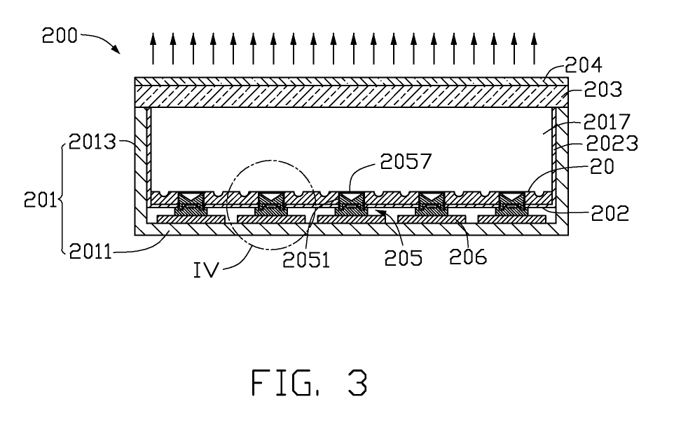

Referring to FIG. 3, a backlight module 200 in accordance with a second preferred embodiment of the present invention is shown. The backlight module 200 includes a housing 201, a light diffusion plate 203, a plurality of side-lighting type LEDs 205, and the optical plate 20. The optical plate 20 as described in the first embodiment is employed in the second embodiment. The housing 201 includes a rectangular base 2011 and four sidewalls 2013 extending around a periphery of the base 2011, the base 2011 and the sidewalls 2013 cooperatively define an opening 2017. The light diffusion plate 203 is disposed atop the housing 201 over the opening 2017 and supported by the sidewalls 2013.

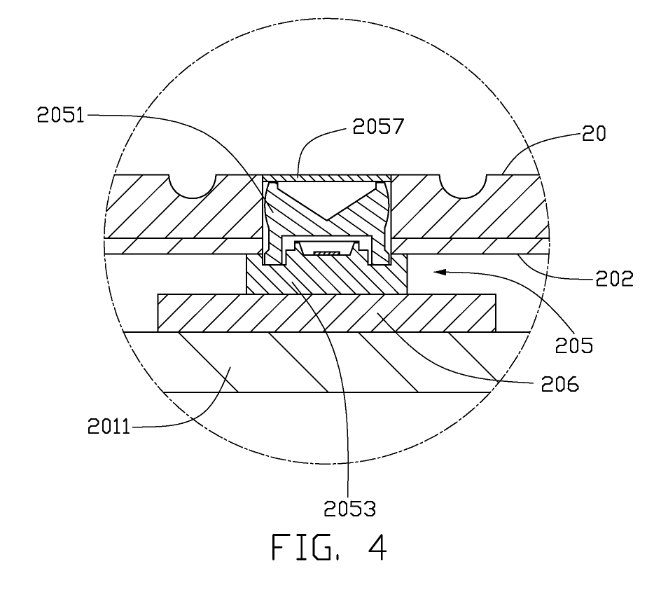

Referring to FIG. 4, each side-lighting type LED 205 includes a base portion 2053, a light-emitting portion 2051 disposed on the base portion 2053, and a reflective member 2057 disposed on a top of the light-emitting portion 2051. The LEDs 205 are electrically connected to a printed circuit board 206 that is fixed to the base 2011 of the housing 201. Light-emitting portions 2051 of the LEDs 205 are inserted into the lamp-receiving portions 214 of the optical plate 20, and the light output surface 212 of the optical plate 20 faces the light diffusion plate 203.

In use, light emitted from the light-emitting portions 2051 of the LEDs 205 enters the optical plate 20 via inner surfaces of the lamp-receiving portions 214. A significant amount of the light is transmitted through the optical plate 20. Since the depressions 215 have a plurality of slanted side surfaces, a great amount of light can be directly refracted at the depressions 215, and the great amount of light quickly exits the light output surface 212. Thus, a light energy utilization rate of the backlight module 200 is increased.

In addition, because the side-lighting type LEDs 205 are positioned in the lamp-receiving portions 214, light is uniformly outputted from the light output surface 212 of the optical plate 20 except that portions directly above the LEDs 205 have a relatively low illumination. Light from the optical plate 20 is substantially blended in a chamber between the optical plate 20 and the light diffusion plate 203 so that uniform surface light is outputted from the light diffusion plate 203. A distance from the LEDs 205 to the light diffusion plate 203 may be configured to be very short, with little or no darkness at an area on the backlight module 200 directly above the LED 205. Accordingly, the backlight module 200 can have a thin configuration while still providing good, uniform optical performance.

In order to improve a light energy utilization rate, the backlight module 200 may further include a light reflective plate 202 defining a plurality of through holes (not labeled) corresponding to the lamp-receiving portions 214 of the optical plate 20. The light reflective plate 202 is disposed underneath the bottom surface 213 of the optical plate 20 with the light-emitting portions 2051 of the LEDs 205 passing through the through holes of the light reflective plate 202 correspondingly. The light reflective plate 202 and the optical plate 20 are supported by the base portions 2053 of the LEDs 205. It should be pointed out that, the light reflective plate 202 can be omitted. In an alternative embodiment, a high reflectivity film can be deposited on inner surfaces of the base 2011 and the sidewalls 2013 of the housing 201. In other alternative embodiment, the housing 201 is made of metal materials, and has high reflectivity inner surfaces.

It is to be understood that, in order to improve brightness of the backlight module 200 at a specific range of viewing angles, the backlight module 200 can further include a prism sheet 204 disposed on the light diffusion plate 203. In addition, in order to improve light energy utilization rate of the backlight module 200, the light reflective plate 202 can further include four reflective sidewalls 2023 extending around a periphery thereof and contacting with the sidewalls 2013 of the housing 201.

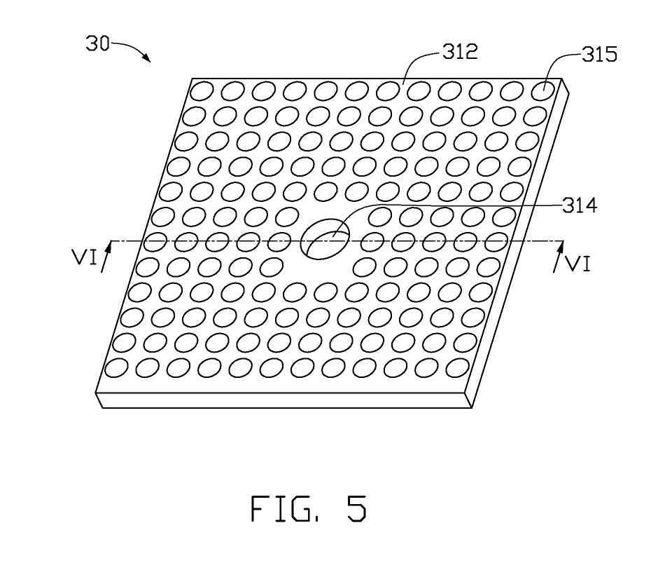

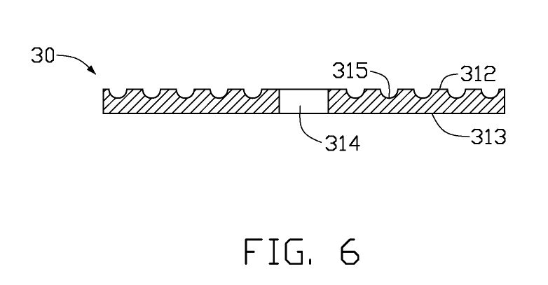

Referring to FIGS. 5 and 6, an optical plate 30 in accordance with a third preferred embodiment is shown. The optical plate 30 is similar in principle to the optical plate 20 of the first embodiment. However, only a lamp-receiving portion 314 is defined in a center of optical plate 30 communicating between a light output surface 312 and a bottom surface 313. Furthermore, a plurality of depressions 315 are formed on the light output surface 312 in a matrix manner except for an immediate area adjacent/surrounding the lamp-receiving portion 314.

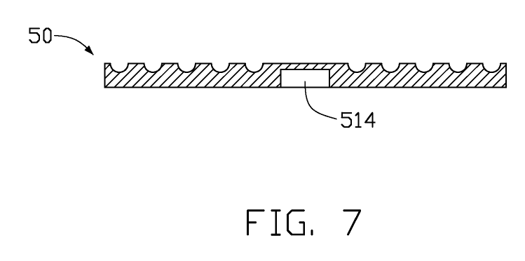

Referring to FIG. 7, an optical plate 50 in accordance with a fourth preferred embodiment is shown. The optical plate 50 is similar in principle to the optical plate 30, except that a lamp-receiving portion 514 of the optical plate 50 is a blind hole. It should be pointed out that, a side-lighting type LED (not shown) without a reflective member can be received in the lamp-receiving portion 514 of the optical plate 50 to form a backlight module. Alternatively, a reflective member of the LED can be also positioned at a center of the optical plate 50 above the lamp-receiving portion 514.

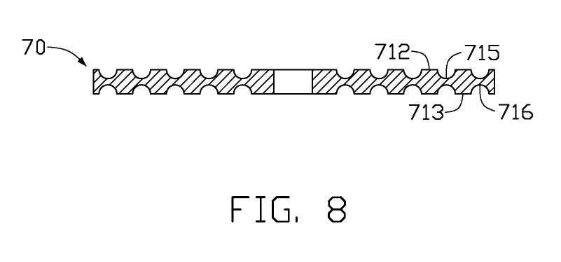

Referring to FIG. 8, an optical plate 70 in accordance with a fifth preferred embodiment is shown. The optical plate 70 is similar in principle to the optical plate 30, except that the optical plate 70 further includes a plurality of second depressions 716 formed on a bottom surface 713 corresponding to the first depressions 715 of a light output surface 712. When the optical plate 70 is used in the backlight module 200 of the second embodiment, some light is reflected by the second depressions 716 and/or the light reflective plate 202 before outputted from the light output surface 212, thereby improving the brightness of light illumination. Furthermore, if the optical plate 70 does not have the second depressions 716 at the bottom surface 713, some of the light undergoes total reflection at the bottom surface 713 so as to still transmit in the optical plate 70. Since the depressions 716 have a plurality of slanted side surfaces, some light can be refracted and project to the reflective plate 202, and finally output from the light output surface 712. Thus, a light energy utilization rate of the backlight module 200 is further increased.

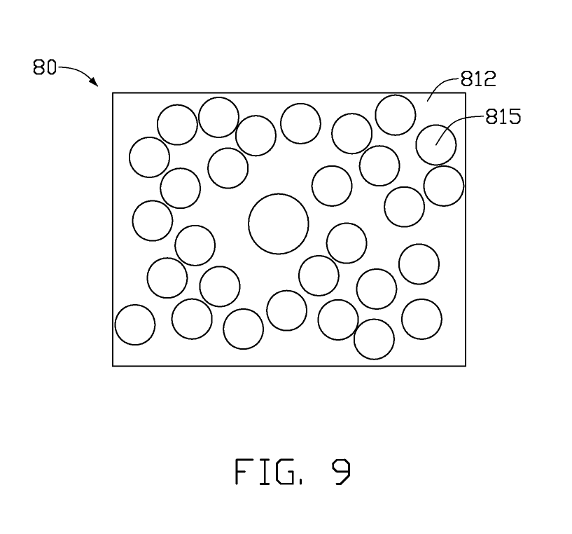

Referring to FIG. 9, an optical plate 80 in accordance with a sixth preferred embodiment is shown. The optical plate 80 is similar in principle to the optical plate 30, except that a plurality of depressions 815 are distributed on a light output surface 812 randomly. In alternative embodiments, depressions formed on a bottom surface may be arranged randomly also.

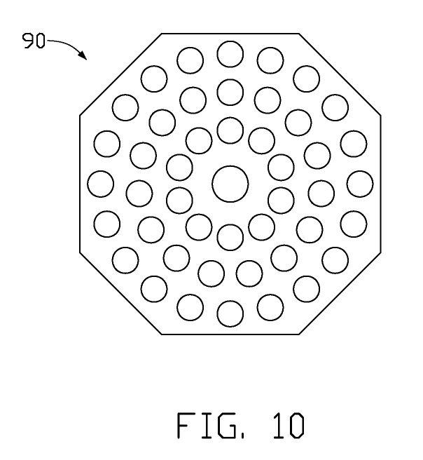

Referring to FIG. 10, an optical plate 90 in accordance with a seventh preferred embodiment is shown. The optical plate 90 is similar in principle to the optical plate 30, except that the optical plate 90 is an octagonal in shape.

It is noted that the scope of the present optical plate is not limited to the above-described embodiments. In particular, even though specific shape of depressions 215, 315, 715 have been described and illustrated, the depressions 215, 315, 715 can have various other suitable shapes. For example, the depressions 215, 315, 715 can be pyramidal depressions, frustums of pyramidal depressions, or columnar depressions.

In the backlight module 200, a plurality of red, green, and blue colored LEDs can be inserted into the lamp-receiving portions of the optical plate 20, such that a blended white surface light can be obtained. It is to be understood that other kinds of point light source, such as field emission lamps and so on, can replace the LED 205 in above embodiments.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate comprising:
at least one transparent plate section having:
a light output surface;
a bottom surface opposite to the light output surface;
a plurality of first depressions formed on the light output surface; and
at least a lamp-receiving portion defined in the bottom surface.

2. The optical plate according to claim 1, wherein each of the first depressions is a spherical depression.

3. The optical plate according to claim 2, wherein a radius defined by each of the first depressions is preferably in a range from about 0.01 millimeters to about 2 millimeters.

4. The optical plate according to claim 2, wherein a maximum depth of each first depressions is in a range from about 0.01 millimeters to about 2 millimeters.

5. The optical plate according to claim 1, wherein the first depressions are formed on the light output surface in a matrix manner.

6. The optical plate according to claim 1, wherein the optical plate is divided into many transparent plate sections that are arranged in a matrix manner, each of the lamp-receiving portions is defined in a center of each of the transparent plate sections, and in each transparent plate section, the first depressions are formed on the light output surface in a rectangular manner surrounding the lamp-receiving portion.

7. The optical plate according to claim 1, wherein the lamp-receiving portion is selected from one of blind hole and through hole communicating between the bottom surface and the light output surface.

8. The optical plate according to claim 1, wherein the at least one transparent plate section further comprises a plurality of second depressions formed on the bottom surface.

9. The optical plate according to claim 8, wherein the first and second depressions are selected from a group consisting of pyramidal depressions, frustums of pyramidal depressions, spherical depressions and columnar depressions.

10. The optical plate according to claim 1, wherein a thickness of the optical plate is in a range from 0.5 millimeters to about 5 millimeters.

11. A backlight module comprising:
a housing having a base and a plurality of sidewalls extending around a periphery of the base, the base and the sidewalls cooperatively defining an opening;
at least one side-lighting type point light source disposed on the base, each point light source having a light-emitting portion;
an optical plate positioned in the housing, the optical plate including at least one transparent plate section having:
a light output surface;
a bottom surface opposite to the light output surface;
a plurality of depressions formed on the light output surface; and
at least a lamp-receiving portion defined in the bottom surface, wherein the light-emitting portion of the at least one point light source is inserted in the lamp receiving portion correspondingly; and
a light diffusion plate disposed on the housing over the opening.

12. The backlight module according to claim 1, further comprising a light reflective plate defining a through hole therein, the light reflective plate being disposed underneath the bottom surface of the optical plate, and the light emitting potion of the point light source passing through the through hole of light reflective plate correspondingly.

13. The backlight module according to claim 12, wherein the light reflective plate further comprises a plurality of reflective sidewalls extending around a periphery thereof and contacting with the sidewalls of the housing.

14. The backlight module according to claim 11, wherein the housing is made of metal materials, and has high reflectivity inner surfaces.

15. The backlight module according to claim 11, further comprising a high reflectivity film deposited on inner surfaces of the base and the sidewalls of the housing.

16. The backlight module according to claim 11, further comprising a prism sheet disposed on the light diffusion plate.

17. The backlight module according to claim 11, wherein the at least one transparent plate section further comprises a plurality of second depressions formed on the bottom surface.

18. The backlight module according to claim 17, wherein the first and second depressions are selected from a group consisting of pyramidal depressions, frustums of pyramidal depressions, spherical depressions and columnar depressions.

19. The backlight module according to claim 11, wherein the lamp-receiving portion is selected from one of blind hole and through hole communicating between the bottom surface and the light output surface.
